(19) United States
(12) Patent Application Publication
(10) Pub. No.: US 2007/0232269 A1
(43) Pub. Date: Oct. 4, 2007

(54) Security device for digital contents and method of using the same

(75) Inventors: Bae-eun Jung, Seongnam-si (KR); Maeng-hee Sung, Seoul (KR); Weon-il Jin, Suwon-si (KR); Hee-jean Kim, Yongin-si (KR); Hwan-joon Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/585,865

(22) Filed: Oct. 25, 2006

Related U.S. Application Data
(60) Provisional application No. 60/787,539, filed on Mar. 31, 2006.

(30) Foreign Application Priority Data
May 23, 2006 (KR) 2006-45962

(51) Int. Cl. H04M 1/66

(52) U.S. Cl. 455/411

(57) ABSTRACT

An improved security device for digital contents and a method for using the security device are provided. The improved security device and method include a transmission and reception unit for transmitting and receiving data necessary for authentication with a mobile device, and for transmitting and receiving contents of the mobile device and a controller for performing authentication with the mobile device, and for decrypting re-encrypted contents from the mobile device when the authentication is successful. The improved method and device provide enhance mobility for users.

### CROSS-REFERENCE TO RELATED APPLICATIONS

This application claims the benefit under 35 U.S.C. §119(e) of U.S. Provisional Application No. 60/787,539, filed Mar. 31, 2006, in the United States Patent and Trademark Office and claims the benefit under 35 U.S.C. §119(a) of Korean Patent Application No. 10-2006-45962, filed May 23, 2006, in the Korean Intellectual Property Office, the entire disclosures of both of which are hereby incorporated by reference.

### BACKGROUND OF THE INVENTION

1. Field of the Invention

The present invention relates to a security device for digital contents and a method using the same. More particularly, the present invention relates to a security device for digital contents according to which a DRM (Digital Rights Management) agent is incorporated in a mobile device to provide mobility of digital contents, and a method using the same.

2. Description of Related Art

A variety of DRM (Digital Rights Management) server software is currently available, which mainly aims to secure safe distribution of paid contents on the web, and prevent unauthorized use. DRM has been introduced to protect digital contents from piracy which is rampant due to increased use of file sharing programs. Despite copyright laws to protect the on-line contents, it is still very difficult to control illegal use of contents and locate the criminals.

Some DRM measures focus on making it impossible for unauthorized users to steal web contents. Many companies have introduced DRM measures with a variety of approaches and technologies.

One example is to allow contents to be used only on a device authorized by the company providing the contents. Accordingly, contents ‘b’ protected with a DRM ‘B’ may only be used in a device of a company ‘B’, and contents ‘a’ protected with a DRM ‘A’ may only be used in a device of a company ‘A’. In this case, a user is inconvenienced because if he has a device of the company ‘B’ installed with the DRM ‘B’, and wants to use the contents ‘a’ protected by the DRM ‘A’ downloaded from the Internet, he cannot use the contents ‘a’ with the device ‘B’ but needs the device ‘A’.

Accordingly, the user has to buy the device ‘A’ to use the contents ‘a’.

Additionally; because private keys are not movable, encryption keys of the contents for the DRM device cannot be obtained. That is, it lacks mobility among the contents protected by the same DRM measure.

Accordingly, there is a need for an improved security device for digital contents and method of using the same.

### SUMMARY OF THE INVENTION

Exemplary embodiments of the present invention address at least the above problems and/or disadvantages and provide at least the advantages described below. Accordingly, an aspect of the present invention is to provide a security device for digital contents, which provides a mobile device with DRM agent to enable a user safely to use DRM-protected contents in a rendering device without the DRM agent.

In order to achieve the above-described aspects of the present invention, a rendering apparatus is provided, which includes a transmission and reception unit which transmits and receives data necessary for authentication with a mobile device, and receives contents to or from the mobile device and a controller which performs authentication with the mobile device, and decrypts the contents from the mobile device when the authentication is successful to render the contents.

The controller performs authentication with the mobile device, by applying one of a broadcast encryption and a public key authentication.

A display unit may also be provided, which displays a list of contents including contents stored in the mobile device, contents provided from a content provider, and contents stored in advance. The controller generates a rendering request message with respect to contents which are selected by a user from the list of contents displayed through the display unit, and the transmission and reception unit transmits the rendering request message, and contents information corresponding to the selected contents to the mobile device. The transmission and reception unit communicates with the mobile device via a secure channel.

The contents transmitted by the transmission and reception unit may be protected with a DRM (Digital Rights Management) measure.

The transmission and reception unit may receive the re-encrypted contents with session keys from the mobile device in the form of streaming data. The controller may decrypt the re-encrypted contents using the session keys shared with the mobile device.

According to one exemplary aspect of the present invention, a method of rendering digital contents may be provided, which includes transmitting and receiving data necessary for authentication with a mobile device, and transmitting and receiving contents to or from the mobile device and controlling such that authentication with the mobile device is performed, and the re-encrypted contents from the mobile device is transmitted when the authentication is successful to render the contents.

In the controlling, the authentication with the mobile device may apply one of a broadcast encryption and a public key authentication.

According to an exemplary aspect, it may include displaying a list of contents including contents stored in the mobile device, contents provided from a content provider, and contents stored in advance may also be provided. In the controlling, a rendering request message may be generated with respect to contents which are selected by a user from the displayed list of contents, and in the transmitting and receiving, the rendering request message, and contents information corresponding to the selected contents are transmitted to the mobile device. In the transmitting and receiving, communication with the mobile device may be performed via a secure channel.

In the transmitting and receiving, the transmitted contents may be protected with a DRM (Digital Rights Management) measure.

In the transmitting and receiving, the re-encrypted contents with session keys may be received from the mobile device in the form of streaming data. In the controlling, the encrypted contents are decrypted using the session keys shared with the mobile device.

According to another exemplary aspect of the present invention, a mobile device is provided, which includes a transmission and reception unit which transmits and receives data necessary for authentication with a rendering apparatus, and transmits and receives contents to or from the rendering apparatus, a DRM agent which decrypts the contents when the authentication is successful, and a controller which re-encrypts the decrypted contents with the session key using shared with the rendering apparatus, and transmits the re-encrypted contents to the rendering apparatus via the transmission and reception unit.

The controller may perform authentication with the rendering apparatus, by applying one of a broadcast encryption and a public key authentication.

The transmission and reception unit may communicate with the rendering apparatus via a secure channel, and transmits the re-encrypted contents in the form of streaming data.

The contents received at the transmission and reception unit may be protected with a DRM (Digital Rights Management) measure. The DRM agent decrypts the contents using a secret key of DRM-protected contents.

The controller may re-encrypt the decrypted contents using session keys shared with the rendering apparatus. The contents are selected by a user from a list of contents which is provided via a user interface of the rendering apparatus.

The DRM agent checks information about license and rights on the contents based on contents information corresponding to the contents, and determines whether the contents corresponding to the contents information is renderable or not. The transmission and reception unit may receive the contents when the DRM agent determines the contents to be renderable.

The controller authenticates the rendering apparatus based on the data necessary for authentication which is received via the transmission and reception unit.

According to another exemplary aspect of the present invention, a method of providing contents is provided, which includes transmitting and receipting data necessary for authentication with a rendering apparatus, and transmitting and receiving contents to or from the rendering apparatus, decrypting the contents when the authentication is successful, and re-encrypting the decrypted contents and transmitting the re-encrypted contents to the rendering apparatus via the transmission and reception unit.

The authentication with the rendering apparatus may apply one of a broadcast encryption and a public key authentication.

In the transmitting and receiving, the communication with the rendering apparatus may be performed via a secure channel, and the re-encrypted contents may be transmitted in the form of streaming data.

In the transmitting and receiving, the contents may be DRM-protected. The contents may be decrypted using a secret key of the DRM-protected contents.

In the transmitting, the decrypted contents may be re-encrypted using session keys shared with the rendering apparatus. The contents may be selected by a user from a list of contents which is provided via a user interface of the rendering apparatus.

The contents selected by the user may comprise at least one of contents stored in advance, contents provided by a contents provider, and contents stored in the rendering apparatus. Accordingly, in the decrypting, the contents selected by the user may be decrypted, and in the transmitting, the decrypted contents may be re-encrypted and transmitted to the rendering apparatus.

The decrypting may also comprise checking information about license and rights on the contents based on contents information corresponding to the contents, and determining whether the contents corresponding to the contents information is renderable or not. In the transmitting and receiving, the contents may be received when determined to be renderable in the decrypting.

### BRIEF DESCRIPTION OF THE DRAWING FIGURES

The above and other aspects of the present invention will be more apparent by describing certain exemplary embodiments of the present invention with reference to the accompanying drawings, in which:

FIG. 1 is a block diagram of a secure consuming system of digital contents according to an exemplary embodiment of the present invention;

FIG. 2 is a flowchart illustrating the method of operating a secure consuming system of digital contents according to an exemplary embodiment of the present invention;

FIG. 3 illustrates the exemplary operation of the secure consuming system of digital contents when the desired contents is stored in the rendering apparatus; and

FIG. 4 illustrates the exemplary operation of the secure consuming system of digital contents when the desired contents is stored in the mobile device.

Throughout the drawings, the same drawing reference numerals will be understood to refer to the same elements, features, and structures.

### DETAILED DESCRIPTION OF EXEMPLARY EMBODIMENTS

Certain exemplary embodiments of the present invention will now be described in greater detail with reference to the accompanying drawings.

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

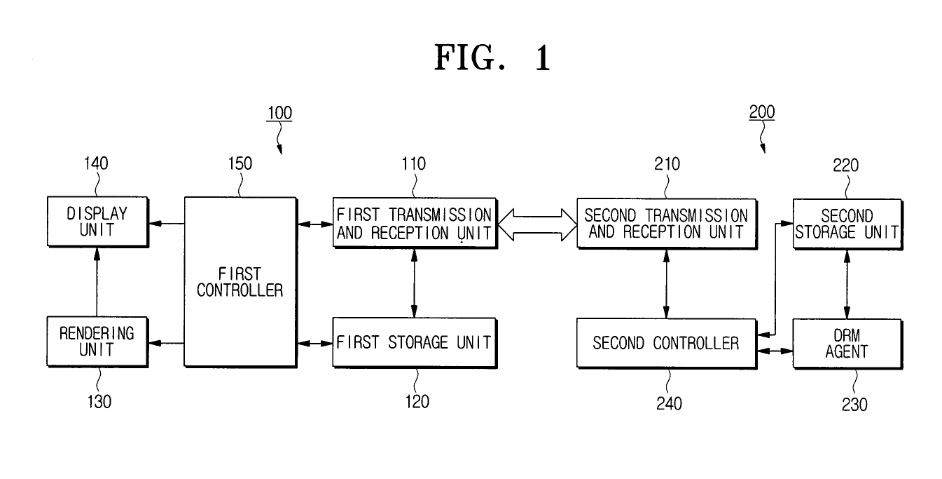

FIG. 1 is a block diagram of a secure system for using digital contents according to an exemplary embodiment of the present invention.

Referring to FIG. 1, a digital contents security system according to one exemplary embodiment of the present invention includes a rendering apparatus 100 which renders re-encrypted contents, and a mobile device 200 having a DRM (Digital Rights Management) agent. The rendering apparatus 100 includes a first transmission and reception unit 110, a first storage unit 120, a rendering unit 130, a display unit 140 and a first controller 150.

The first transmission and reception unit 110 receives key blocks from the mobile device 200 for the purpose of authentication. The authentication can be applied between the first controller 150 and the mobile device 200

The first transmission and reception unit 110 additionally transmits contents information about the contents selected by a user, a contents rendering request message, and DRM-protected contents to the mobile device 200. The first transmission and reception unit 110 receives the contents selected by the user from a contents provider (not shown) or the mobile device 200. The first transmission and reception unit 110 in this example receives re-encrypted contents.

The first storage unit 120 stores the contents provided from the contents provider (not shown) and the mobile device 200 via the first transmission and reception unit 110, and keys of the rendering apparatus 100. DRM-protected contents may be provided from the contents provider (not shown) and the mobile device 200, although it should not be construed as limiting.

The rendering unit 130 processes the selected contents to render a signal and outputs the signal. That is, the rendering unit 130 processes unlocked contents to a form that is viewable or audible by the user.

The display unit 140 displays a list of contents of the contents provider (not shown) accessible by the rendering apparatus 100, a list of contents stored in the first storage unit 120, and a list of contents stored in the mobile device 200.

The display unit 140 additionally provides a user interface between the rendering apparatus 100 and the user, and displays the contents processed by the rendering unit 130 to the user.

The first controller 150 acquires the shared keys with the mobile device 200 for authentication, using the stored keys of the rendering apparatus 100 and the key blocks received from the first transmission and reception unit 110. That is, the first controller 150 extracts information corresponding to the keys of the rendering apparatus 100 from the key blocks received at the first transmission and reception unit 110, and decrypts the extracted information to acquire shared keys with the mobile device 200 for the purpose of authentication.

The first controller 150 additionally generates a contents rendering request message with respect to the contents selected by the user, and outputs the generated request message to the first transmission and reception unit 110. The first controller 150 then decrypts the re-encrypted contents received from the mobile device 200 and outputs the resultant data to the rendering unit 130.

The first controller 150 also controls the display unit 140 so that the display unit 140 displays the list of contents stored in the mobile device 200 which is received via the first transmission and reception unit 110, the list of contents stored in the first storage unit 120 and the list of contents provided by the contents provider (not shown).

Meanwhile, according to one exemplary aspect of the present invention, the mobile device 200 in the secure consuming system of digital contents includes a second transmission and reception unit 210, a second storage unit 220, a DRM agent 230, and a second controller 240. The mobile device 200 may preferably be implemented as a memory card, a memory stick, or any adequate mobile storage medium.

The DRM agent 230 checks the information regarding licenses and rights on the contents based on the contents information received via the second transmission and reception unit 210, and determines whether the received contents may be rendered or not.

The second transmission and reception unit 210 transmits the key blocks of the mobile device 200 to the rendering apparatus 100 for the second controller 240 to share the session keys with the rendering apparatus 100, and to form a secure channel. The second transmission and reception unit 210 may receive authentication information from the rendering apparatus 100 in the case of public key authentication with the rendering apparatus 100.

The second transmission and reception unit 210 receives contents information about the contents selected by the user, and a contents rendering request message from the rendering apparatus 100. When it is determined by the DRM agent 230, which is explained below, that the contents may be rendered, the second transmission and reception unit 220 receives the DRM-protected contents from the rendering apparatus 100 or the contents provider (not shown).

The second transmission and reception unit 210 additionally transmits the contents, which are re-encrypted with the session keys by the second controller 240, to the rendering apparatus 100. The contents are transmitted to the rendering apparatus 100 in the form of streaming data.

The second storage unit 220 stores the DRM-protected contents which is provided from the contents provider (not shown) or the rendering apparatus 100 via the second transmission and reception unit 210. The DRM agent 230 may additionally store information such as a secret key of the mobile device 200, a secret key of the DRM-protected contents, session keys used in forming a secure channel, license of the contents, and the like.

The DRM agent 230 checks the license and rights of the selected contents by the user, based on the contents information received through the second transmission and reception unit 210, and determines whether the received contents may be rendered or not.

The DRM agent 230 also decrypts the DRM-protected contents selected by the user.

That is, the DRM agent 230 decrypts the DRM-protected contents received from the rendering apparatus 100, or the DRM-protected contents read in from the second storage unit 230. The DRM agent 230 decrypts the DRM-protected contents using the secret key of the DRM-protected contents with reference to the second storage unit 220.

The DRM agent 230 may additionally manage contents usage information including the number of times or the time period that the contents may be rendered.

The second controller 240 authenticates the rendering apparatus 100 based on the authentication information such as a certificate received through the second transmission and reception unit 210, and re-encrypts the decrypted contents using the session keys.

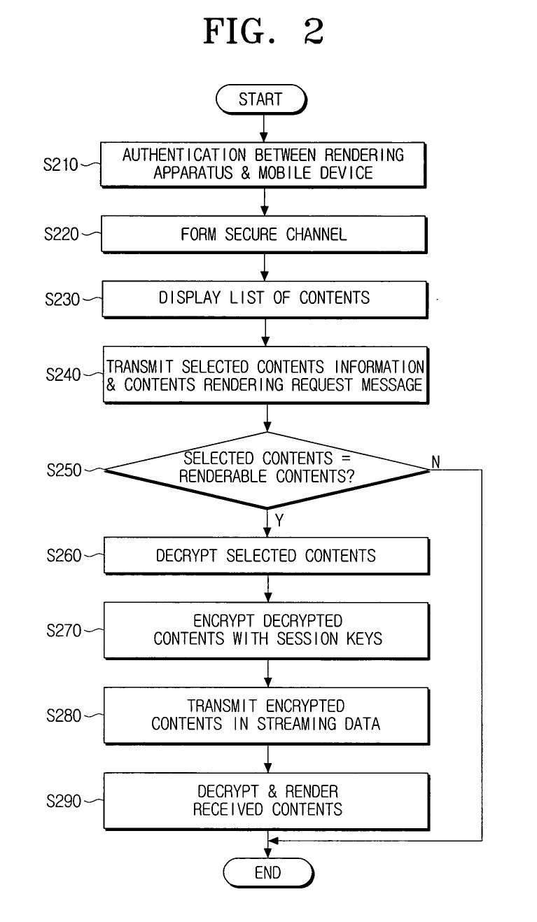

FIG. 2 is a flowchart illustrating a method of operating a secure consuming system of digital contents according to an exemplary embodiment of the present invention.

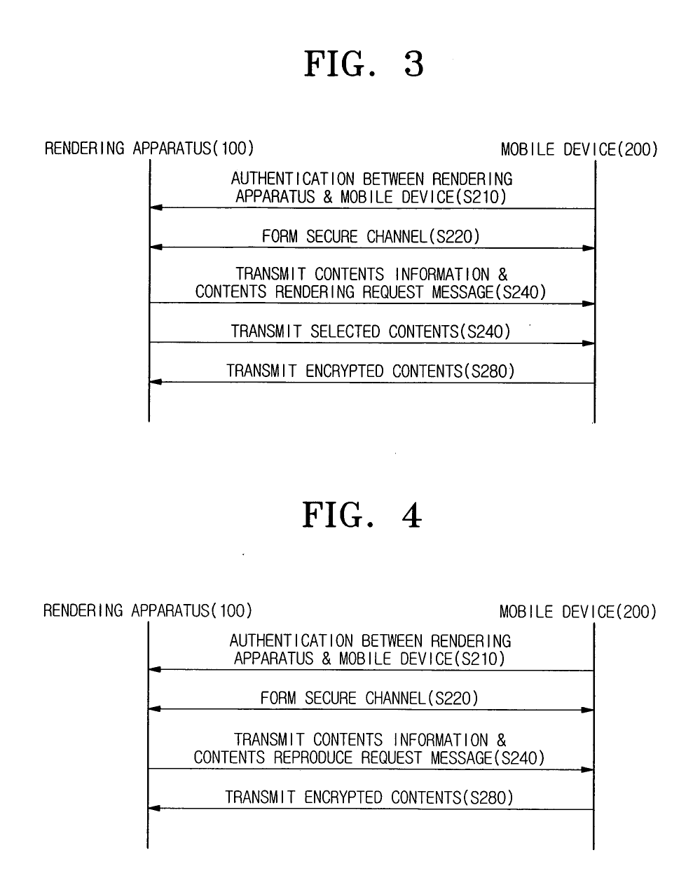

FIG. 3 illustrates an exemplary operation of the digital contents security system when the desired contents are stored in the rendering apparatus, and FIG. 4 illustrates an exemplary operation of the secure consuming system of digital contents when the desired contents are stored in the mobile device.

Referring to FIGS. 2 through 4, the authentication S210 between the rendering apparatus 100 and the mobile device 200 will be explained.

The second transmission and reception unit 210 transmits key blocks of the mobile device 200 to the rendering apparatus 100, and the first controller 150 extracts information corresponding to the keys of the rendering apparatus 100 from the key blocks received via the first transmission and reception unit 110. The first controller 150 then decrypts the extracted information to acquire shared keys with the mobile device 200 for the purpose of authentication. The first controller 150 transmits a response message to the mobile device 200 in response to the authentication request message using the acquired secret key, and the mobile device 200 authenticates the rendering apparatus 100 as a reliable device when the received response message comprises a correct response value to the authentication request message.

When the authentication with the rendering apparatus 100 is completed, the second controller 240 shares the session keys with the rendering apparatus 100 to form a secure channel in operation S220. The rendering apparatus 100 and the mobile device 200 communicate through the secure channel formed as explained above.

The first controller 150 displays a list of contents accessible by the rendering apparatus 100 through the display unit 140 in operation S230.

That is, the first controller 150 controls the display unit 140 so that the display unit 140 displays a list of contents stored in the mobile device 200 which is received via the first transmission and reception unit, and a list of contents stored in the first storage unit 120, and also displays the list of contents accessible by the rendering apparatus 100 via a network (not shown) which may be provided by the contents provider (not shown).

The first controller 150 transmits to the mobile device 200 contents information about the contents selected from the list of contents displayed on the display unit 140, and the contents rendering request message.

That is, when the contents to be rendered are selected by the user from the list of contents of operation S230, the first controller 150 generates a contents rendering request message about the selected contents and transmits the request message to the mobile device 200 via the first transmission and reception unit 110 in operation S240. The first controller 150 transmits the contents information containing the contents ID to the mobile device 200 together with the contents rendering request message.

The DRM agent checks the information about the license and rights on the contents based on the contents information received via the second transmission and reception unit 210, and determines whether the received contents may be rendered or not in operation S250.

That is, the DRM agent 230 checks the license and the number of times the contents may be rendered, and rights such as valid period, and when determining that there is license and rights on the contents, determines that the selected contents may be rendered.

When it is determined that the selected contents may be rendered, the DRM agent 230 decrypts the renderable contents in operation S260. The contents selected by the user may be DRM-protected, although it should not be construed as limiting.

With reference to FIG. 3, when the renderable contents are stored in the rendering apparatus 100, or provided by the contents provider (not shown), the DRM agent 230 decrypts the renderable contents using the secret key of the DRM-protected contents. That is, when the selected contents are determined to be renderable as shown in FIG. 3, the DRM agent 230 decrypts the DRM-protected contents which are received via the second transmission and reception unit 210. When the renderable contents are stored in the second storage unit 220 as shown in FIG. 4, the DRM agent 230 decrypts the renderable contents read in from the second storage unit 220 using the secret key of the DRM-protected contents.

The second controller 240 then encrypts the decrypted contents, using the session keys in operation S270.

The second transmission and reception unit 210 transmits the re-encrypted contents to the rendering apparatus 100 in operation S280. The re-encrypted contents may be transmitted in the forming of streaming data.

The first controller 150 decrypts the re-encrypted contents which are received via the first transmission and reception unit 110, and outputs the decrypted data in operation S290.

That is, the first controller 150 decrypts the received re-encrypted contents using the session keys, and outputs the decrypted contents to the rendering unit 130. The rendering unit 130 processes the decrypted contents and outputs the contents in the viewable or audible format. As a result, the user can view or listen to the selected contents.

In the secure consuming system of digital contents according to an exemplary embodiment of the present invention, operation S230 of displaying the list of contents can be performed prior to operation S210 of performing authentication between the mobile device 200 and the rendering apparatus 100.

Additionally, a public key authentication can be applied in the authentication between the mobile device 200 and the rendering apparatus 100.

That is, the mobile device 200 performs authentication with the rendering apparatus 100, by determining the validity of the authentication document which is transmitted from the rendering apparatus 100. Because a secure channel is formed and the protected contents are transmitted via the secure channel and decrypted, contents selected by the user can be rendered.

As described above, with a mobile device containing DRM agent provided according to the exemplary embodiments of the present invention, mobility of contents improves so that the DRM-protected contents can be securely rendered in a device without a corresponding DRM agent.

Because authentication and a secure channel are provided between the rendering apparatus 100 and the mobile device 200, contents are rendered only in a duly authenticated rendering apparatus 100. Therefore, secure mobility of contents is provided.

The present invention can also be embodied as computer-readable codes or instructions on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains

While the invention has been shown and described with reference to certain embodiments thereof, it will be understood by those skilled in the art that various changes in form and details may be made therein without departing from the spirit and scope of the invention as defined by the appended claims and the full scope of equivalents thereof.

What is claimed is:

1. A rendering apparatus, comprising:
a transmission and reception unit for transmitting and receiving data necessary for authentication with a mobile device, and for transmitting and receiving contents of the mobile device; and
a controller for performing authentication with the mobile device, and for decrypting re-encrypted contents from the mobile device when the authentication is successful.

2. The rendering apparatus of claim 1, further comprising:
a rendering unit for rendering decrypted contents.

3. The rendering apparatus of claim 1, wherein the controller performs authentication with the mobile device by applying one of a broadcast encryption and a public key authentication.

4. The rendering apparatus of claim 1, further comprising:
a display unit for displaying a list of contents comprising at least one of contents stored in the mobile device, contents provided from a content provider, and contents stored in advance, wherein
the controller generates a rendering request message with respect to contents which are selected by a user from the list of contents displayed through the display unit, and
the transmission and reception unit transmits the rendering request message, and contents information corresponding to the selected contents to the mobile device.

5. The rendering apparatus of claim 1, wherein the transmission and reception unit communicates with the mobile device via a secure channel.

6. The rendering apparatus of claim 1, wherein the contents transmitted by the transmission and reception unit are protected with a DRM (Digital Rights Management) measure.

7. The rendering apparatus of claim 1, wherein the transmission and reception unit receives re-encrypted contents with session keys from the mobile device in the form of streaming data.

8. The rendering apparatus of claim 7, wherein the controller decrypts the re-encrypted contents using the session keys wherein the session keys are shared with the mobile device.

9. A method of rendering digital contents, the method comprising:
transmitting and receiving data necessary for authentication with a mobile device;
transmitting and receiving contents to or from the mobile device;
performing authentication with the mobile device; and
decrypting and the re-encrypted contents from the mobile device when the authentication is successful.

10. The rendering method of claim 9, wherein the performing authentication with the mobile device comprises applying one of a broadcast encryption and a public key authentication.

11. The rendering method of claim 9, further comprising:
displaying a list of contents comprising at least one of contents stored in the mobile device, contents provided from a content provider, and contents stored in advance, wherein
the performing authentication comprises generating a rendering request message with respect to contents which are selected by a user from the displayed list of contents and the transmitting and receiving contents comprises transmitting the rendering request message and contents information corresponding to the selected contents to the mobile device.

12. The rendering method of claim 9, wherein the transmitting and receiving contents comprises performing communication with the mobile device via a secure channel.

13. The rendering method of claim 9, wherein the transmitting and receiving contents comprises protecting the transmitted contents with a DRM (Digital Rights Management) measure.

14. The rendering method of claim 9, wherein the transmitting and receiving contents comprises receiving the re-encrypted contents with session keys from the mobile device in the form of streaming data.

15. The rendering method of claim 14, wherein the performing authentication comprises decrypting the re-encrypted contents using the session keys wherein the session keys are shared with the mobile device.

16. A mobile device, comprising:
a transmission and reception unit for transmitting and receiving data necessary for authentication with a rendering apparatus, and for transmitting and receiving contents to or from the rendering apparatus;
a DRM agent for decrypting the contents; and
a controller for encrypting the decrypted contents, and transmitting the re-encrypted contents to the rendering apparatus via the transmission and reception unit, when the authentication is successful.

17. The mobile device of claim 16, wherein the controller performs authentication with the rendering apparatus by applying one of a broadcast encryption and a public key authentication.

18. The mobile device of claim 16, wherein the transmission and reception unit communicates with the rendering apparatus via a secure channel, and transmits the re-encrypted contents in the form of streaming data.

19. The mobile device of claim 16, wherein the contents received at the transmission and reception unit are protected with a DRM (Digital Rights Management) measure.

20. The mobile device of claim 19, wherein the DRM agent decrypts the contents using a secret key of DRM-protected contents.

21. The mobile device of claim 20, wherein the controller re-encrypts the decrypted contents using session keys shared with the rendering apparatus.

22. The mobile device of claim 16, wherein the contents are selected by a user from a list of contents which is provided via a user interface of the rendering apparatus.

23. The mobile device of claim 16, wherein the DRM agent checks information about license and rights on the contents based on the contents information corresponding to the contents, and for determining whether the contents corresponding to the contents information may be rendered or not, and
the transmission and reception unit receives the contents when the DRM agent determines that the contents may be rendered.

24. The mobile device of claim 16, wherein the controller authenticates the rendering apparatus based on the data necessary for authentication which is received via the transmission and reception unit.

25. A method of providing contents, comprising:
transmitting and receiving data necessary for authentication with a rendering apparatus;
transmitting and receiving contents to or from the rendering apparatus;
decrypting the contents;
re-encrypting the decrypted contents; and
transmitting the re-encrypted contents to the rendering apparatus via the transmission and reception unit, when the authentication is successful.

26. The method of claim 25, wherein the transmitting and receiving comprises applying one of a broadcast encryption and a public key authentication for the authentication with the rendering apparatus.

27. The method of claim 25, wherein the transmitting and receiving comprises transmitting and receiving the contents to or from the rendering apparatus via a secure channel and the transmitting the encrypted contents comprises transmitting the re-encrypted contents in the form of streaming data.

28. The method of claim 25, wherein the transmitting and receiving contents comprises transmitting and receiving contents protected by a DRM (Digital Rights Management) measure.

29. The method of claim 28, wherein decrypting the contents comprises decrypting the contents using a secret key of the DRM-protected contents.

30. The method of claim 29, wherein the transmitting the encrypted contents comprises re-encrypting the decrypted contents using session keys shared with the rendering apparatus.

31. The method of claim 25, further comprising selecting the contents by a user from a list of contents which is provided via a user interface of the rendering apparatus.

32. The method of claim 31, the selecting the contents comprises selecting contents from at least one of contents stored in advance, contents provided by a contents provider, and contents stored in the rendering apparatus,
the decrypting comprises decrypting the contents selected by the user,
and the transmitting comprises re-encrypting the decrypted contents and transmitting the re-encrypted contents to the rendering apparatus.

33. The method of claim 25, wherein the decrypting comprises checking information about license and rights on the contents based on contents information corresponding to the contents, and determining whether the contents corresponding to the contents information may be rendered or not, and
the transmitting and receiving comprises receiving the contents when the contents are determined to be renderable in the decrypting.

34. The method of claim 25, wherein the transmitting comprises authenticating the rendering apparatus based on the data necessary for authentication which is received in the transmitting and receiving.

35. A computer-readable medium having embodied thereon a set of instructions for computer program for rendering digital contents, the instructions comprising:
a first set of instructions for transmitting and receiving data necessary for authentication with a mobile device;
a second set of instructions for transmitting and receiving contents to or from the mobile device;
a third set of instructions for performing authentication with the mobile device; and
a fourth set of instructions for decrypting the contents from the mobile device when the authentication is successful to render the contents.

36. The computer-readable medium of claim 35, wherein the third set of instructions comprises instructions for applying one of broadcast encryption and a public key authentication.

37. The computer-readable medium of claim 35, further comprising:
a fifth set of instructions for displaying a list of contents comprising at least one of contents stored in the mobile device, contents provided from a content provider, and contents stored in advance, wherein
the third set of instructions comprises instructions for generating a rendering request message with respect to contents which are selected by a user from the displayed list of contents and the second set of instructions comprises instructions for transmitting the rendering request message and contents information corresponding to the selected contents to the mobile device.

38. The computer-readable medium of claim 35, wherein the second set of instructions comprises instructions for performing communication with the mobile device via a secure channel.

39. The computer-readable medium of claim 35, wherein the second set of instructions comprises instructions for protecting the transmitted contents with a DRM (Digital Rights Management) measure.

40. The computer-readable medium of claim 35, wherein the second set of instructions comprises instructions for receiving the re-encrypted contents with session keys from the mobile device in the form of streaming data.

41. The computer-readable medium of claim 40, wherein the fourth set of instructions comprises instructions for decrypting the encrypted contents using the session keys wherein the session keys are shared with the mobile device.
